(19) United States
(12) Patent Application Publication
(10) Pub. No.: US 2009/0104289 A1
(43) Pub. Date: Apr. 23, 2009

(54) FORMULATION OF ANTIMICROBIAL FILM, COATINGS AND/OR SPRAYS CONTAINING PORTULACA OLERACEA EXTRACT AND FILM PREPARED THEREFROM

(76) Inventor: Ji Hyun BAE, Daegu (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/016,388

(22) Filed: Jan. 18, 2008

(30) Foreign Application Priority Data
Oct. 19, 2007 (KR) 10-2007-0105827

(51) Int. Cl. A01N 65/00; A01P 15/00

(52) U.S. Cl. 424/725

(57) ABSTRACT

An antimicrobial film formulation is prepared by extracting Portulaca oleracea using chloroform, petroleum ether or hot water, filtering and concentrating the extract, processing the concentrated extract into a liquid or powder state, and completely dissolving 0.25-0.5% (w/v) of the Portulaca oleracea extract, 1.5-2% (w/v) of chitosan and 0.5-2% (w/v) of glycerol in 100% (v/v) of vinegar (containing about 3-5% acetic acid).

### CROSS-REFERENCE TO RELATED APPLICATIONS

The present application is based on and claims priority from Korean Patent Application No. 10-2007-0105827 filed on 19 Oct. 2007, the disclosure of which is hereby incorporated by reference in its entirety.

### BACKGROUND OF THE INVENTION

1. Field of the Invention

The present invention relates to an antimicrobial film formulation for food packaging, which can be used as a coating material or a spray solution(hereinafter, referred to as “film formulation”) to effectively store food and to prolong the shelf life of food, as well as an antimicrobial film prepared from the film formulation.

2. Background of the Related Art

Food spoilage microorganisms and food-borne pathogens are the most major factors impeding the quality and safety of food and should be inhibited during the storage, processing and distribution of food. For this purpose, various antimicrobial techniques have been developed, and among them, studies on the development of packaging materials having antimicrobial functionality have recently been actively conducted.

In the prior art, in order to prolong the shelf life of food, many film packaging materials have been developed. Antimicrobial packaging materials are broadly classified into two categories: materials having antimicrobial activity in themselves; and materials for use as carriers required to receive other antimicrobial materials.

Chitosan (a linear polysaccharide composed of randomly distributed β-(1-4)-linked D-glucosamine (deacetylated unit) and N-acetyl-D-glucosamine (acetylated unit)) which has a number of commercial and possible biomedical uses., finds application in the present invention as will become clear hereinlater. Although chitosan possess antimicrobial activity, it is frequently used as a carrier for receiving other antimicrobial materials, rather than being used as films or coatings which are made only of chitosan. That is, antimicrobial materials are artificially added to polymer materials such as chitosan, in order to increase the antimicrobial activity of the resulting films. Examples of materials, which are added to the polymer materials for this purpose, include organic acid, Nisin, Pediocin, Paraben, Imazalil, ally isothiocyanate and the like.

Due to consumer's rejection of the use of synthetic preservatives, studies focused on the addition of natural antimicrobial materials such as green tea extract have recently received attention. However, the kinds of natural antimicrobial materials known to date, and examples of the application thereof to films, are very small in number. Korean Patent Laid-Open Publication No. 10-2005-0055808 discloses a method for manufacturing an edible film using green tea extract. However, the disclosed edible film is an oral hygiene film for inhibiting Streptococcus mutans.

Moreover, in connection with the sanitary management of fruits or vegetables, washing processes and the like are used to reduce the number of various harmful microorganisms. However, the effect of this is relatively insignificant. Also, there have been many studies indicating that the use of coatings, spray solutions or films can more effectively and continually disinfect these microorganisms. This is because the constituents of the film is exposed directly to the surface of food and dissolved out with the passage with time, and thus they can more effectively inhibit the growth of microorganisms on the surface of food. For this reason, there has been an urgent need to develop antibacterial films or coatings containing natural antimicrobial materials, which can greatly assist in prolonging the storage and shelf life of various foods, including fruits or vegetables. Prior documents relating to Portulaca oleracea extract include: U.S. Pat. No. 6,451,358, which discloses the use of a composition, comprising Portulaca oleracea, vinegar, brown sugar and the like, for the treatment of vitiligo; U.S. Pat. No. 7,060,303, which discloses the use of Portulaca oleracea for wrinkle treatment or skin improvement; U.S. Pat. No. 5,824,312, which discloses the use of Portulaca oleracea in sunscreen agents; U.S. Pat. No. 6,153,208, which discloses the use of Portulaca oleracea in non-steroidal soothing cosmetics; U.S. Pat. No. 6,338,855, which discloses a Portulaca oleracea extract having antimicrobial and antifungal effects; U.S. Pat. No. 5,869,060 which discloses a Portulaca oleracea extract for use in cancer therapy; JP. Pat. No. 63,208,531, which discloses a Portulaca oleracea extract, which is used as an anti-diabetic agent due to the blood glucose regulating effect; U.S. Pat. Publication No. 20050064049, which discloses a Portulaca oleracea extract, which is used as an anti-obesity agent due to the effect of stimulating the lypolysis of fat accumulated in adipose tissue; U.S. Pat. Publication No. 20040228822, which discloses a Portulaca oleracea extract, which is used to treat skin conditions such as acne; U.S. Pat. Publication No. 20040191208, which discloses a Portulaca oleracea extract, which is used in a cosmetic composition for men's skin care and hair care; U.S. Pat. No. 7,252,831, which discloses a Portulaca oleracea extract, which is used in a composition for treating the development of ingrown hairs; and J. Medical Sciences 7(2): 238-242, 2007, which discloses a water-soluble extract of Portulaca oleracea, which is used as a muscle relaxant.

### SUMMARY OF THE INVENTION

Accordingly, the present invention is directed to providing an antimicrobial film formulation, containing Portulaca oleracea extract, which is known to contain antimicrobial components and has been used for edible or medical purposes for a long time, as well as an antimicrobial film, a coating material and a spray solution, which are prepared using the antimicrobial formulation. That is, the present invention is directed to providing a film formulation and a stable film prepared therefrom, in which the effects of the Portulaca oleracea extract and chitosan are maximized and which have the highest antimicrobial activity.

The present invention has been developed in order to achieve the above.

Portulaca oleracea is an edible plant and contains large amounts of various nutrients and functional materials, and thus, when it is subjected to extraction, the antimicrobial activity thereof can be maximized, and a stable film having excellent properties can be prepared.

According to an experiment conducted with the present invention, the antimicrobial activity of Portulaca oleracea disappears when it is extracted using hot water above 98° C., and that an extract having antimicrobial activity can be obtained when Portulaca oleracea is extracted using hot water at a relatively low temperature of 68° C. In addition, in the process of extracting Portulaca oleracea with hot water, when salt is added in an amount of 1.5 wt % based on the weight of Portulaca oleracea, an extract having a higher antimicrobial activity can be obtained. This extract shows an antimicrobial effect higher than that of an extract obtained by extracting Portulaca oleracea in hot water at 68° C. or by extracting Portulaca oleracea in alcohol such as distilled liquor. However, if salt is added in an amount of more than 1.5 wt %, the taste of the resulting Portulaca oleracea extract tends to be too salty, and thus the addition of salt in an amount of more than 1.5 wt % is not preferred in sensory terms.

The Portulaca oleracea extract, prepared as described above, showed high antimicrobial activity at a concentration of about 5,000 ppm. However, the addition of the extract at a concentration higher than 5,000 ppm did not show a significant increase in antimicrobial activity. Thus, the extract needs to be added at a concentration of at least 5,000 ppm in order to exhibit high antimicrobial effects. Also, in an example for preparing the film formulation according to the present invention, the Portulaca oleracea extract was added at various concentrations of 0.01-0.5% (w/v) based on the volume of vinegar. As a result, it can be seen that the Portulaca oleracea extract should be added in an amount of 0.25-0.5% (w/v) in order to provide a film having maximized antimicrobial activity. In addition, in order to obtain a stable film, other components such as chitosan or glycerol should be added at suitable concentrations together with the Portulaca oleracea extract. That is, chitosan was added as a carrier at a concentration of 1-2% (w/v) based on the volume of vinegar and, as a result, it could be seen that, when chitosan was added as a carrier at a concentration of 1.5-2% (w/v) together with the Portulaca oleracea extract, the most stable film could be formed. Also, glycerol has the greatest effect on the film, and thus it was applied at a wide concentration range of 0.5-8% (w/v) based on the volume of vinegar. As a result, it could be seen that, when glycerol was added at a concentration of 0.5-2% (w/v), the most suitable film was obtained. If glycerol was added at a concentration of less than 0.5% (w/v), a film containing the Portulaca oleracea extract at a concentration up to 0.5% (w/v), which showed maximized antimicrobial activity, could not be prepared, and a film containing only 2% (w/v) of chitosan could be prepared. However, the inventive antimicrobial film containing the Portulaca oleracea extract showed an increase in antimicrobial activity of more than 20%, compared to the film containing only chitosan. Also, if the concentration of glycerol was more than 2% (w/v) based on the volume of vinegar, the resulting film became too soft, such that it could not act as the film intended in accordance with the present invention.

If glycerol is used at an excessively high concentration in an edible film, it will affect the taste of the film. For this reason, it should be used in a minimal amount, which does not impede the antimicrobial activity of the film and can sufficiently maintain the physical properties of the film. In the present invention, a film containing 0.5-2% (w/v) of glycerol could be developed. Thus, an antimicrobial film formulation, which has the highest antimicrobial effect and is bio-degradable and beneficial to the human body, can be developed by mixing, based on the volume of vinegar, 0.25-0.5% (w/v) of the Portulaca oleracea extract, technically prepared as described above, with 1.5-2% (w/v) of chitosan and 0.5-2% (w/v) of glycerol, and completely dissolving the mixture in 100% (v/v) of vinegar (having an acetic acid content of about 3-5%).

The reason why vinegar is used as the solvent in the inventive antimicrobial film formulation is that it is an edible solvent having antimicrobial activity in itself, and it is naturally evaporated even in air due to a content of about 3-5% acetic acid, contained therein, without needing any special treatment, such as heating or vacuum drying, such that the film can be easily dried.

A film prepared from said film formulation was examined for stability as a film shape or storage stability as a coating material. As a result, even when the film was stored at room temperature for 6 months or more, neither a change in physical shape nor layer separation could be observed, suggesting that the film formulation has excellent storage stability.

A main object of a food package is to maintain the quality of food and to stably store the food during the period the food is produced and distributed to consumers. For this purpose, a film, a coating material or a spray solution can be used, and in order to form the most efficient and economical film or film formulation, the components thereof should be effective, inexpensive and easily available materials.

Portulaca oleracea, which is the major component of the inventive formulation, is a medical and edible material, which is widely found throughout the world, including North America, Asia, Africa, Australia, and the Middle East, and is advantageous in that it is readily available and is inexpensive. Also, chitosan is an edible bio-degradable polysaccharide which is almost as abundant as cellulose and is therefore readily available.

In addition, the components of the inventive formulation are all edible, bio-based materials, and the inventive formulation is advantageous in that it can be popular not only with producers, but also with consumers, because it consists of non-toxic, bio-degradable, environmental-friendly, safe materials. Also, in the case of vinegar being used as the solvent for dissolving the components of the inventive formulation, about 3-5% acetic acid contained therein allows a film-forming carrier such as chitosan to be easily dissolved, and the solvent naturally evaporates. For this reason, it allows the film to be easily obtained by drying it in air at room temperature without needing any particular treatment, such as heating or vacuum drying. Also, due to the viscous properties of mucopolysaccharides, wax or pectin, contained in Portulaca oleracea that is a key component of the inventive formulation, a film, which can readily adhere to all objects for a long time, is prepared. Various nutrient components and pharmacological functional components of Portulaca oleracea, which dissolve out of this film, increase the added value of the film with the passage of time.

The inventive film formulation (coating material or spray solution) and the inventive film can also be effectively used for the treatment of skin diseases such as atopy or vitiligo (see, for example, U.S. Pat. No. 6,451,358, which discloses the use of a composition, comprising the Portulaca oleracea extract, vinegar, brown sugar and the like, for the treatment of vitiligo) and can be applied for sites bitten by insects, burns, scratches, inflammations, boils, swells and the like (Chiej. R. Encyclopedia of Medicinal Plants; A Barefoot Doctors Manual; Lassak. E. V. and McCarthy. T. Australian Medicinal Plants; Foster. S. and Duke. J. A. A Field Guide to Medicinal Plants, Eastern and Central N. America; Bown. D. Encyclopedia of Herbs and their Uses). Also, it can be used either as a vermicide or as an internal-use product for the treatment of cataract and digestive disorder (Duke. J. A. and Ayensu. E. S. Medicinal Plants of China; Chopra. R. N., Nayar. S. L. and Chopra. I. C. Glossary of Indian Medicinal Plants), and can be used as an external-use product for the treatment of skin diseases, caused by microorganisms, such as fungi, viruses or bacteria, or acne (see U.S. Pat. Publication No. 20040228822, which discloses the use of Portulaca oleracea extract for the treatment of skin conditions such as acne), and for the treatment of water eczema. In addition, it can be effectively used for wrinkle treatment, aging prevention or skin improvement (see U.S. Pat. No. 7,060,303, which discloses the use of the Portulaca oleracea extract for wrinkle treatment or skin improvement), and can also be used as a suture tape for suturing a wound after surgery.

Furthermore, it can be applied or spread to the scalp in order to stimulate hair growth (see U.S. Pat. No. 7,252,831, which discloses Portulaca oleracea extract, which is used to treat the development of ingrown hairs, and can be attached to muscles in the form of pain relief patch or pain relieving medication (poultice, cataplasm, cream, ointment, and gel) in order to relax the muscles or to massage the muscles (see J. Medical Sciences 7(2): 238-242, 2007, which discloses a water-soluble extract of Portulaca oleracea, which is used as a muscle relaxant). In addition, it can be used as a sliming agent, which is applied directly to the skin to obtain lipolysis stimulation (see U.S. Pat. Publication No. 20050064049, which discloses a Portulaca oleracea extract, which is used as an anti-obesity agent due to the effect of stimulating the lypolysis of fat accumulated in adipose tissue). As described above, the inventive film formulation or film can be used in various applications, and due to the unique advantages as described above, when it is used as an antimicrobial food packaging film or film formulation, it can safely store and manage food for a long period of time. Accordingly, the inventive film formulation or film is considered to be a highly effective invention.

### BRIEF DESCRIPTION OF THE DRAWINGS

The above and other applications, features and advantages of the present invention will be apparent from the following detailed description of the preferred embodiments of the invention in conjunction with the accompanying drawings, in which:

FIG. 1 shows a film prepared by sufficiently mixing, based on the volume of vinegar, 0.25-0.5% (w/v) of a chloroform extract of Portulaca oleracea, 1.5-2% (w/v) of chitosan, 0.5-2% (w/v) of glycerol and 100% (v/v) of vinegar (containing about 3-5% acetic acid) with each other at room temperature for 24 hours, and then drying the mixture in air for 3 days;

FIG. 2 shows a film prepared by sufficiently mixing, based on the volume of vinegar, 1.5-2% (w/v) of chitosan, 0.5-2% (w/v) of glycerol and 100% (v/v) of vinegar (containing about 3-5% acetic acid) with each other at room temperature for 24 hours, and then drying the mixture in air for 3 days;

FIG. 3 shows a film prepared by sufficiently mixing, based on the volume of vinegar, 0.25-0.5% (w/v) an autoclave at 68° C. extract of Portulaca oleracea, 1.5-2% (w/v) of chitosan, 0.5-2% (w/v) of glycerol and 100% (v/v) of vinegar (containing about 3-5% acetic acid) with each other at room temperature for 24 hours, and then drying the mixture in air for 3 days; and

FIG. 4 shows a film prepared by sufficiently mixing, based on the volume of vinegar, 0.25-0.5% (w/v) of a petroleum ether extract of Portulaca oleracea, 1.5-2% (w/v) of chitosan, 0.5-2% (w/v) of glycerol and 100% (v/v) of vinegar (containing about 3-5% acetic acid) with each other at room temperature for 24 hours, and then drying the mixture in air for 3 days.

### DETAILED DESCRIPTION OF THE PREFERRED EMBODIMENT

The present invention provides an antimicrobial film and film formulation, which is more stable and has a higher antimicrobial effect.

In the present invention, the antimicrobial film formulation was verified to have antifungal activity with respect fungus Botrytis cinerea, which is most problematic in a process of storing and distributing fruits and vegetables, such as strawberries. Strawberries are a fruit which is popular with consumers every year, because it has attractive color and taste. However, it is likely to deteriorate because it has a soft fruit fresh and a high water content, compared to those of other fruits. In addition, the shelf life thereof is very short due to the development of fungus. Meanwhile, when fungus Botrytis cinerea, which is a main cause for the deterioration of strawberries, contaminates grapes, it degrades the waxy substance of the grape skin to stimulate water evaporation from the skin, thus wrinkling the skin.

For this reason, experiments were carried out on fungus Botrytis cinerea, which is most hazardous during the cultivation and storage of strawberries. Portulaca oleracea, which is one of the components of the inventive antimicrobial film formulation, is an annual plant and is also called “O-hang-cho”, “Jang-myung-chae”, “Ma-chi-chae” in Korean, etc. It grows naturally in waysides, kitchen gardens and the like, and the stem thereof, having a height of about 15-30 cm, is brown-red in color and grows sideways on the ground. Particularly, even though it is a plant, it is rich in substances, such as omega-3-fatty acid, noradrenaline and dopamine, and contains large amounts of wax, water-soluble polysaccharides, including pectin substances, and various vitamins, amino acids, organic acids and glycosides (see Table 1, and U.S. Pat. No. 5,869,060, which discloses Portulaca oleracea extract for use in cancer therapy). Such Portulaca oleracea is prepared into food by mixing it with spices or is also used as a medical drug. Recently, it has been reported to show good effects for antioxidation or anticancer (action of dopamine), heart trouble (action of K+ ions), anti-inflammation (action of omega-3-fatty acid), diabetes (blood glucose regulation by omega-3-fatty acid), etc.

TABLE 1
Major components of Portulaca oleracea

| | |
|---|---|
| 1. | Noradrenaline |
| 2. | Dopa |
| 3. | Dopamine |
| 4. | Cardiac-glycoside |
| 5. | Anthraquinone-glycoside |
| 6. | Glucose |
| 7. | Sucrose |
| 8. | Fructose |
| 9. | Coumarin |
| 10. | Amino acids |
| 11. | Saponins |
| 12. | Alkaloids |
| 13. | Flavonoids |
| 14. | Citric acid |
| 15. | Oxalic acid |
| 16. | Glutamic acid |
| 17. | Asparaginic acid |
| 18. | Malic acid |
| 19. | Tannnic acid |
| 20. | Vitamins A, B1, B2, C |
| 21. | Catechol |
| 22. | Urea |
| 23. | Wax |
| 24. | Betacyanin |
| 25. | K-salt (KCl, K2SO4, KNO3) |
| 26. | K2O |
| 27. | Fe |

The Portulaca oleracea extract, which is one of the components of the inventive formulation, is obtained by extracting Portulaca oleracea using various organic solvents or hot water, filtering and concentrating the extract, and freeze-drying the concentrate into a liquid or powder state.

As used herein, the term “petroleum ether extract of Portulaca oleracea” refers to an extract obtained by immersing Portulaca oleracea in petroleum ether at room temperature for 5 hours or more, filtering and concentrating the extract, and processing the concentrate into a liquid or powder state.

As used herein, the term “chloroform extract of Portulaca oleracea” refers to an extract obtained by immersing Portulaca oleracea in chloroform at room temperature for 5 hours or more, filtering and concentrating the extract, and processing the concentrate into a liquid or powder state.

As used herein, the term “autoclave at 68° C. extract of Portulaca oleracea” refers to an extract obtained by adding salt to washed and dried Portulaca oleracea in an amount corresponding to 1.5 wt % of the weight of the Portulaca oleracea, adding water thereto in an amount two times the weight of the Portulaca oleracea, heating, pressing and extracting the mixture in an autoclave at 68° C., filtering the extract, and processing the filtrate into a liquid or powder state.

When Portulaca oleracea was extracted in hot water at a temperature higher than 98° C., the antimicrobial components thereof were destroyed, and thus the extract showed an antimicrobial activity significantly lower than that of the extract obtained by extraction in hot water at 68° C. Also, when salt was added at a concentration of 1.5 w/w % based on the weight of Portulaca oleracea, the antimicrobial activity of the Portulaca oleracea extract was greatly increased, suggesting that the extraction of antimicrobial substances from Portulaca oleracea was more effectively achieved. Accordingly, in accordance with the present invention, the Portulaca oleracea extract, obtained by adding salt to Portulaca oleracea in an amount of 1.5 w/w % based on the weight of the Portulaca oleracea, adding water thereto in an amount corresponding to two times the weight of the Portulaca oleracea, subjecting the mixture to hot water extraction at 68° C. for 5 hours, and processing the extract into a liquid or powder state, was used to an edible, antimicrobial formulation and film.

Hereinafter, the present invention will be described in further detail with reference to the following examples. It is to be understood, however, that these examples are illustrative only, and the scope of the present invention is not limited thereto.

### EXAMPLE 1

An experiment was performed in the following manner using the above-prepared Portulaca oleracea extract and chitosan. First, the inhibitory effect of the Portulaca oleracea extract on the growth of fungus Botrytis cinerea, which fatally influences the storage of strawberries, was examined. In the growth inhibitory experiment, each of the Portulaca oleracea extract and chitosan were added to a potato dextrose agar (PDA) medium in a Petri dish at various concentrations and hardened. Then, a Botrytis cinerea spot having a diameter of 8 mm was placed in the center of the medium and was cultured in an incubator at 20° C. for 5 days. After completion of the culture, the diameter of the grown fungus was measured, the measured diameter was compared with that of a fungus control group cultured in the absence of the Portulaca oleracea extract or chitosan, thereby verifying the growth inhibitory effect. As a result, as shown in Table 2 below, the Portulaca oleracea extracts showed a strong growth inhibitory effect with respect to fungus Botrytis cinerea, which was higher in the order of the chloroform extract of Portulaca oleracea, the petroleum ether of Portulaca oleracea, the ethyl acetate extract of Portulaca oleracea, and the autoclave at 68° C. extract of Portulaca oleracea, and chitosan.

TABLE 2
Growth inhibitory effect of Portulaca oleracea extracts on Botrytis cinerea (unit: mm)

| | Concentration of Portulaca oleracea extract | | |
|---|---|---|---|
| | 100 ppm (diameter of | 1000 ppm (diameter | 5000 ppm (diameter |
| Kind of Portulaca | grown fungus after 5 | of grown fungus after | of grown fungus after |
| oleracea extract | days) | 5 days) | 5 days) |
| Control group * | 85 | 85 | 85 |
| Petroleum ether | 70 | 60 | 36 |
| Chloroform | 67 | 51 | 19 |
| Ethyl acetate | 76 | 73 | 53 |
| Methanol | 76 | 72 | 72 |
| Distilled water | 84 | 84 | 83 |
| Autoclave at 68° C. ** | 66 | 61 | 59 |
| Chitosan | 80 | 75 | 61 |

* Control group was obtained by dispensing only 70% ethanol to a PDA medium without adding the Portulaca oleracea extract, and then placing on the medium a fungal spot having a size of 8 mm; and
** a medicine-preparing pot extract of Portulaca oleracea was prepared by adding salt to Portulaca oleracea in an amount of 1.5 wt % based on the weight of the Portulaca oleracea, adding water thereto in an amount two times the weight of the Portulaca oleracea, heating and extracting the mixture in an autoclave at 68° C. for 5 hours, and then freeze-drying the extract into a powder state.

As can be seen in Table 2 above, the chloroform extract of Portulaca oleracea showed the highest antimicrobial activity with respect to Botrytis cinerea, and it killed more than 78% of the fungus for 5 days even at a low concentration of 5,000 ppm. The next highest antimicrobial effect was shown in the order of the petroleum ether extract of Portulaca oleracea, the ethyl acetate extract of Portulaca oleracea and the autoclave at 68° C. extract of Portulaca oleracea. When chitosan was applied at a concentration of 5,000 ppm, it showed an antimicrobial activity similar to that of the autoclave at 68° C. extract of Portulaca oleracea. Chitosan is generally known to show an antimicrobial effect even at a very low concentration of 200 ppm, but it did not show a significant antimicrobial/antifungal effect with respect to Botrytis cinerea, used in this experiment, even at a concentration of 100 ppm or 1000 ppm.

### EXAMPLE 2

On the basis of the above-described experimental results, in order to develop the most suitable formulation, which has the highest antimicrobial activity and shows maximized storage stability when it is used as a coating material or a spray solution, a secondary experiment was carried out. Specifically, film formulations were prepared by mixing, based on the volume of vinegar, 0.01-0.5% (w/v) of various Portulaca oleracea extracts, 1-2% (w/v) of chitosan, 0.5-8% (w/v) of glycerol and 100% (v/v) of vinegar. Various Portulaca oleracea extracts, chitosan, glycerol and vinegar were mixed with each other at various concentrations and, as a result, it could be found that, when 0.25-0.5% (w/v) of the Portulaca oleracea extract, 1.5-2% (w/v) of

chitosan and 0.5-2% (w/v) of glycerol were dissolved in 100 v/v % of vinegar (containing about 3-5% acetic acid), the most suitable formulation was obtained.

This formulation was applied to combat fungus Botrytis cinerea, which is a major cause of deteriorating the quality of strawberries during the storage thereof. As a result, it showed an antimicrobial activity of 57% during a culture period of 7 days.

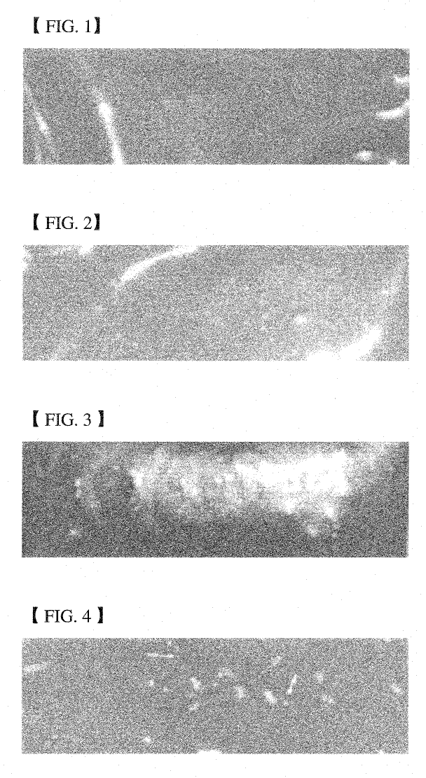

When the formulation was dried in air at room temperature for 3 days, a stable film, which has an excellent color, thickness and elasticity, could be obtained (see FIGS. 1 to 4). The film prepared from this film formulation can be used as a food package material or an edible film piece, and when this formulation is used as a spray solution placed in a compressor pump container or the like, it will act as a sterilizing/disinfecting solution effective for fruits or vegetables.

Particularly, when the formulation is sprayed on fruits and dried, a thin antimicrobial coating film, which is effective for the long-term storage of the fruits, is formed. Also, with the passage of time, the secondary nutrient and functional values of the Portulaca oleracea extract, which is dissolved out from the coating composition, can be obtained. When this film formulation was stored in a closed container at room temperature for 6 months or more, any physical phenomenon, such as precipitation or coagulation, did not occur, and layer separation did not also occur, suggesting that the film formulation was a stable spray solution. In order to verify the antimicrobial effect of the inventive formulation, the antibacterial activity of the formulation with respect to Botrytis cinerea was analyzed. The analysis results are shown in Table 3 below.

TABLE 3
Antimicrobial effect of film formulation with respect to
Botrytis cinerea during various culture periods (unit: mm)

| Kind of film | Cultured | Cultured | Cultured |
|---|---|---|---|
| formulation | for 5 days | for 6 days | for 7 days |
| Control group 1 | 80 | 85 | 88 |
| Film formulation 1 | 34 | 35 | 38 |
| Film formulation 2 | 48 | 50 | 52 |
| Film formulation 3 | 47 | 49 | 50 |
| Film formulation 4 | 44 | 45 | 48 |
| Film formulation 5 | 44 | 45 | 46 |
| Film formulation 6 | 59 | 61 | 62 |
| Film formulation 7 | 40 | 42 | 43 |
| Film formulation 8 | 48 | 49 | 51 |

In Table 3, the control group 1 was obtained by dispensing only 70% ethanol to a PDA medium without adding any film formulation, and then placing on the medium a fungal spot having a size of 8 mm.

The film formulation 1 was prepared by sufficiently mixing 0.5% (w/v) of the chloroform extract of Portulaca oleracea, 2% (w/v) of chitosan, 0.625% (w/v) of glycerol and 100% (v/v) of vinegar with each other at room temperature for 24 hours and was used for film preparation and as a coating material and a spray solution.

The film formulation 2 was prepared by sufficiently mixing 0% (w/v) of the chloroform extract of Portulaca oleracea, 2% (w/v) of chitosan, 0.625% (w/v) of glycerol and 100% (v/v) of vinegar with each other at room temperature for 24 hours and was used for film preparation and as a coating material and a spray solution.

The film formulation 3 was prepared by sufficiently mixing 0.5% (w/v) of the chloroform extract of Portulaca oleracea, 0% (w/v) of chitosan, 0.625% (w/v) of glycerol and 100% (v/v) of vinegar with each other at room temperature for 24 hours and was used for film preparation and as a coating material and a spray solution.

The film formulation 4 was prepared by sufficiently mixing 0% (w/v) of the chloroform extract of Portulaca oleracea, 0% (w/v) of chitosan, 0.625% (w/v) of glycerol and 100% (v/v) of vinegar with each other at room temperature for 24 hours and was used for film preparation and as a coating material and a spray solution.

The film formulation 5 was prepared by sufficiently mixing 0.5% (w/v) of the autoclave at 68° C. extract of Portulaca oleracea, 2% (w/v) of chitosan, 0.625% (w/v) of glycerol and 100% (v/v) of vinegar with each other at room temperature for 24 hours and was used for film preparation and as a coating material and a spray solution.

The film formulation 6 was prepared by sufficiently mixing 0.5% (w/v) of the autoclave at 68° C. extract of Portulaca oleracea, 0% (w/v) of chitosan, 0.625% (w/v) of glycerol and 100% (v/v) of vinegar with each other at room temperature for 24 hours and was used for film preparation and as a coating material and a spray solution.

The film formulation 7 was prepared by sufficiently mixing 0.5% (w/v) of the petroleum ether extract of Portulaca oleracea, 2% (w/v) of chitosan, 0.625% (w/v) of glycerol and 100% (v/v) of vinegar with each other at room temperature for 24 hours and was used for film preparation and as a coating material and a spray solution.

The film formulation 8 was prepared by sufficiently mixing 0.5% (w/v) of the petroleum ether extract of Portulaca oleracea, 0% (w/v) of chitosan, 0.625% (w/v) of glycerol and 100% (v/v) of vinegar with each other at room temperature for 24 hours and was used for film preparation and as a coating material and a spray solution.

As can be seen from the results in Table 3 above, the formulation having the highest antimicrobial activity with respect to Botrytis cinerea was the film formulation 1, which was prepared by sufficiently mixing, based on the volume of vinegar, 0.5% (w/v) of the chloroform extract of Portulaca oleracea, 2% (w/v) of chitosan, 0.625% (w/v) of glycerol and 100% (v/v) of vinegar with each other at room temperature for 24 hours. The film prepared from the formulation showed stability during a storage period longer than 6 months and also showed an antimicrobial activity of 57% up to 7 days after the start of culture of Botrytis cinerea. Also, the film formulation 7, prepared by sufficiently mixing, based on the volume of vinegar, 0.5% (w/v) of the petroleum ether extract of Portulaca oleracea, 2% (w/v) of chitosan, 0.625% (w/v) of glycerol and 100% (v/v) of vinegar with each other at room temperature for 24 hours, showed an antimicrobial activity of 51% up to 7 days after the start of culture of Botrytis cinerea. Moreover, the film formulation 5, containing 0.5% (w/v) of the autoclave at 68° C. extract of Portulaca oleracea, which was prepared by adding, based on the weight of Portulaca oleracea, 1.5 wt % of salt and 200 wt % of water to Portulaca oleracea, and then extracting the mixture in hot water at 68 □C for 5 hours, showed an antimicrobial activity of 48%, suggesting that it can be used an edible antimicrobial coating material and film. Also, the film formulations containing the Portulaca oleracea extract showed an increase in antimicrobial activity of more than about 20% compared to that of the film formulation 2, which contained no Portulaca oleracea extract, that is, contained chitosan as a carrier for film formation.

Although many techniques of adding antimicrobial substances to a film or a coating solution, or many patents relating to the techniques, have already been published, a material or film coated by spraying the inventive formulation containing the Portulaca oleracea extract can adhere to fruits, vegetables or other objects for a longer period of time, because of the viscous mucopolysaccharides, including pectin substances, and lipids, including wax, which are contained in Portulaca oleracea. Generally, microorganisms causing the spoilage of food are mainly present on the surface of food, and thus the antimicrobial activity of the film formulation can be further increased, because the antimicrobial substances can more efficiently adhere to the surface of microorganisms at a high concentration due to the viscous properties thereof. The inventive antimicrobial formulation can be used as a coating material or a spray solution for fresh fruits or vegetables through spraying or dipping, and when the Portulaca oleracea extract is used to prepare a film, the film can contain nutrients, such as vitamins and minerals, together with omega-3-fatty acid and antioxidants. Also, the film can show an advantageous effect in terms of after-taste, because it contains vegetable extract. In addition, the film shows a positive color due to the brown pigment of Portulaca oleracea. The inventive film formulation and the film prepared therefrom can be effectively applied to various fields relating to Portulaca oleracea extracts, including strawberries, various fruits or vegetables, foods, and other materials to which the pharmacological effect of Portulaca oleracea can be applied.

Although the preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An antimicrobial film formulation, which is prepared by mixing, based on the volume of vinegar:
0.25-0.5% (w/v) of a Portulaca oleracea extract;
1.5-2% (w/v) of chitosan;
0.5-2% (w/v) of glycerol; and
100% (v/v) of vinegar;
with each other at room temperature for a predetermined period.

2. An antimicrobial film formulation as set forth in claim 1, wherein the predetermined period is about 24 hours.

3. An antimicrobial film, which is prepared from the formulation of claim 1, according to a conventional method for preparing films.

4. The antimicrobial film formulation of claim 1, wherein the Portulaca oleracea extract is any one selected from the group consisting of a chloroform extract of Portulaca oleracea, a Portulaca oleracea extract, obtained by adding salt to Portulaca oleracea in an amount of 1.5 wt % based on the weight of the Portulaca oleracea, and then extracting the mixture in hot water at 68° C., and a petroleum ether extract of Portulaca oleracea.

5. A method of preparing an antimicrobial film formulation comprising:
extracting Portulaca oleracea using one of chloroform, petroleum ether, or hot water;
filtering and concentrating the extract;
processing the concentrated extract into a liquid or powder state; and
dissolving 0.25-0.5% (w/v) of the Portulaca oleracea extract, 1.5-2% (w/v) of chitosan and 0.5-2% (w/v) of glycerol in 100% (v/v) of vinegar.

6. The method set forth in claim 5, wherein the hot water extraction is carried by adding salt to Portulaca oleracea in an amount of 1.5 wt % based on the weight of the Portulaca oleracea, and then extracting the mixture in hot water at not more than 68° C.

7. An antimicrobial film formulation, comprising:
0.25-0.5% (w/v) of a Portulaca oleracea extract, based on the volume of vinegar;
1.5-2% (w/v) of chitosan;
0.5-2% (w/v) of glycerol; and
100% (v/v) of vinegar.

8. The antimicrobial film formulation set forth in claim 8 wherein the Portulaca oleracea extract comprises one selected from the group of:
a chloroform extract of Portulaca oleracea;
a Portulaca oleracea extract, obtained by adding salt to Portulaca oleracea in an amount of 1.5 wt % based on the weight of the Portulaca oleracea, and then extracting the mixture in hot water at 68° C.; and
a petroleum ether extract of Portulaca oleracea.
